(19) United States
(12) Patent Application Publication
(10) Pub. No.: US 2008/0009988 A1
(43) Pub. Date: Jan. 10, 2008

(54) Location determinative method for controlling an engine to automatically regulate vehicle cabin temperature

(76) Inventor: William R. Metzger, Valley Falls, KS (US)

Correspondence Address: INVENTION PROTECTION ASSOCIATES, LLC, 744 N. Clark Street, #702, CHICAGO, IL, 60610, US

(21) Appl. No.: 11/428,643

(22) Filed: Jul. 5, 2006

(51) Int. Cl. G06F 17/00

(52) U.S. Cl. 701/36; 701/1

(57) ABSTRACT

A location determinative method and system for controlling an engine to automatically regulate cabin temperature within a parked vehicle that is equipped with a heating/cooling apparatus, the method including determining the current location of the vehicle using a satellite navigation system, retrieving from memory location-specific parameters of engine operation and automatically controlling idling of the engine, in compliance with locally applicable law, for the purpose of enabling the heating/cooling apparatus to maintain a desirable cabin temperature.

### BACKGROUND OF THE INVENTION

The present invention relates to a system and method for regulating the cabin temperature of a parked vehicle.

Generally, as the gas price rises, the importance of finding ways to reduce fuel consumption increases with it. That axiom is particularly true for transportation and shipping businesses, as fuel costs can be one of the largest business expenses incurred by such companies. A primary reason for high fuel consumption is the hauling of heavily weighted cargo trailers over long distances. Another reason is prolonged engine idling. For example, a truck operator will often idle the engine of his truck to power the heating and air conditioning system, enabling it to operate while he rests inside the cabin of the parked vehicle. Thus, engine idling may be necessary to maintain the cabin at a comfortable temperature during non-driving when the outdoor temperature is uncomfortably hot or cold.

It is estimated that a typical diesel truck engine burns approximately one gallon of diesel fuel per hour of idling. So, a significant amount of costly fuel may be consumed purely for the purpose of allowing a driver to rest comfortably within the truck cabin. Consequently, the trucking industry has, for some time, recognized a particular need to develop and improve ways of controlling engine idling in order to increase overall fuel economy. Furthermore, in addition to controlling engine idling in a manner which conserves fuel, a truck operator may need to consider various idling constraints prescribed by state and local laws. In fact, several jurisdictions have enacted so called “anti-idle” laws which generally impose time restrictions on vehicle engine idling for the purpose of reducing emissions. For example, the State of New York enacted an anti-idle law that prohibits heavy-duty vehicles from idling more than five consecutive minutes, except under limited circumstances.

An increasingly popular way to minimize or altogether avoid the practice of running the engine merely for cabin temperature regulation purposes is to employ an auxiliary power unit (APU). An APU supplies power to vehicle auxiliary devices, such as the heating and cooling system, so that they may function while the vehicle's primary engine is dormant. The APU runs on its own engine which, typically, is much smaller and more fuel efficient than the vehicle engine. Therefore, using an APU to operate the heating and cooling system can have the effect of reducing fuel consumption associated with regulating air temperature inside of a parked vehicle. However, there are potential drawbacks of APU use. First, obtaining the multiple devices needed to equip an entire truck fleet can be cost prohibitive for a freight company. Second, for a variety of reasons, auxiliary power devices may not be compatible with all vehicles. Third, installing an APU may significantly increase the total weight of the vehicle, as an APU can weigh in excess of 700 pounds. Therefore, while using an APU may reduce fuel consumption during non-driving periods, it may have the partially offsetting effect of increasing fuel consumption during actual driving.

Therefore, employing a system which automatically controls engine operation in a way that regulates cabin temperature with minimal idling may be the most desirable proposition for many vehicle operators. In fact, the prior art is replete with such systems and methods for their use. For example, U.S. Pat. No. 5,317,998 to Hanson, et al. discloses several versions of a method for automatically starting and stopping a truck engine in order to conserve fuel while regulating the truck cabin temperature, and U.S. Pat. No. 5,072,703 to Sutton discloses an apparatus for doing the same.

Nevertheless, in light of evolving anti-idle laws and their lack of uniformity from jurisdiction to jurisdiction, there exists a further need for a system for controlling an engine, be it a main vehicle engine or an auxiliary power engine, in order to regulate vehicle cabin temperature in a manner which complies with law relative to engine operation within the jurisdiction that a vehicle is currently situated. The present invention substantially fulfills this need.

### SUMMARY

The present invention is directed to a method and system for automatically maintaining a desirable cabin temperature within a parked vehicle by controlling idling of the engine in a manner consistent with locally applicable anti-idle laws. More specifically, the present system comprises, at minimum: (1) a navigation system for identifying the geographic location of the vehicle; (2) a memory device for storing engine idling parameters which are specific to various geographic jurisdictions; and (3) a an on-board computer controller for communicating with the navigation system and memory and then moderating engine idling such that the applicable state and local idling restrictions are automatically complied with. Furthermore, the system may comprise temperature sensors and an operator module which, together, allow a driver to select a desired cabin temperature (or range thereof) and the computer to further moderate engine operation so as to maintain a desirable cabin temperature inasmuch as local idling parameters permit.

Therefore, it is an object of the present invention to provide a method and system for automatically regulating vehicle cabin temperature by running an engine as may be necessary to enable a heating and cooling system to keep the cabin environment within a temperature range acceptable to a resting driver. Under the present method, the vehicle or its auxiliary power device may automatically be started when the vehicle's cabin temperature falls or rises outside of the driver's selected comfort range.

It is also an object of the present invention to provide a method and system for regulating vehicle cabin temperature by operating an engine within pre-selected operational parameters specific to the vehicle's current location. The inventive system comprises stored information regarding engine idling restrictions for various geographic territories, and it uses a global positioning satellite (GPS) navigation system to identify the current vehicle location. The vehicle's computer controller, which is programmed to automatically initiate and subsequently stop engine operation, then receives and processes data from the GPS system and the memory to incorporate into its engine control logic any stored idling restrictions relevant to the vehicle's location. Therefore, some engine operation parameters which are intended to maintain a desirable cabin temperature may be overridden by more restrictive location-specific operation parameters. This process can ensure that a vehicle operator will be compliant with state and local idle laws of which may not have been cognizant.

Another object of the present invention is to allow a vehicle fleet operator to impose engine idling restrictions on the vehicles under his control. The location-specific parameters of engine operation can mirror pertinent law (e.g., stopping the engine at the expiration of a statutorily imposed maximum continuous idle time), or they can be crafted by the fleet operator. For instance, a fleet operator may wish to impose idling time limits that are even more restrictive than the applicable legal limits for fleet trucks sitting in California because of the high cost of refueling in California relative to that in other areas of the country. Engine operation parameters can be loaded into and updated within the memory device accordingly.

It is a further object of the present invention to provide safety controls that prevent the engine from automatically starting when certain conditions are present. For example, when the vehicle's parking brake is not engaged or its transmission is in driving gear or its hood is open, the computer can be programmed to override its engine start instruction. These safety controls are designed such that the engine may automatically start only when attendant conditions indicate that the vehicle is safely parked and that no person is working within its engine compartment.

These and other objects of the present invention will become apparent upon review of the following detailed description and drawings.

### BRIEF DESCRIPTION OF THE DRAWINGS

FIG. 1 is a block diagram showing an engine control system according to an embodiment of the present invention;

FIG. 2 is a block diagram showing an engine control system according to an alternative embodiment of the present invention that includes a plurality of safety controls; and

FIG. 3 is a flowchart illustrating operation of a system for controlling an engine according to an embodiment of the present invention.

FIG. 4 is a concept diagram of the location determinative engine control system of the present invention.

### DETAILED DESCRIPTION OF THE PREFERRED EMBODIMENTS

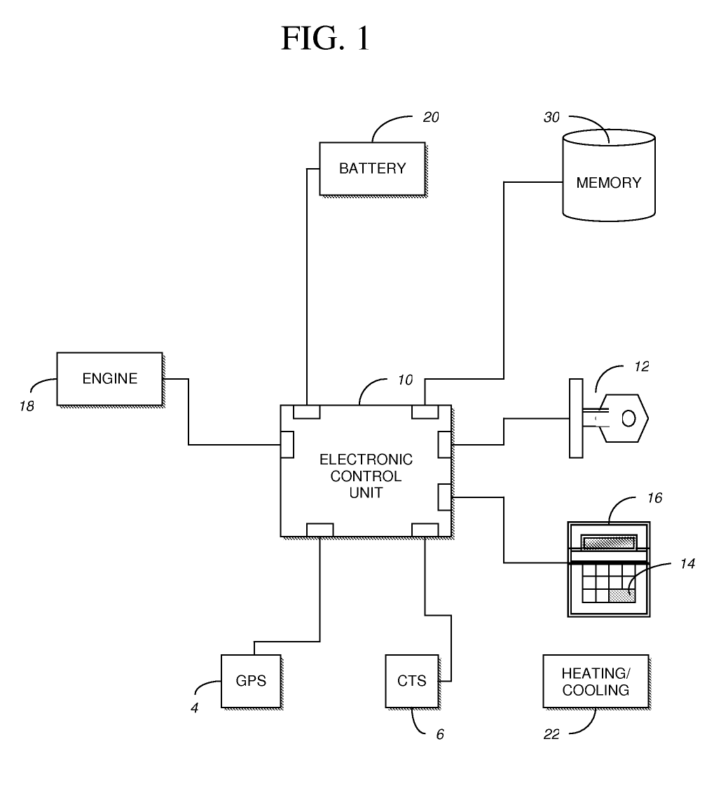

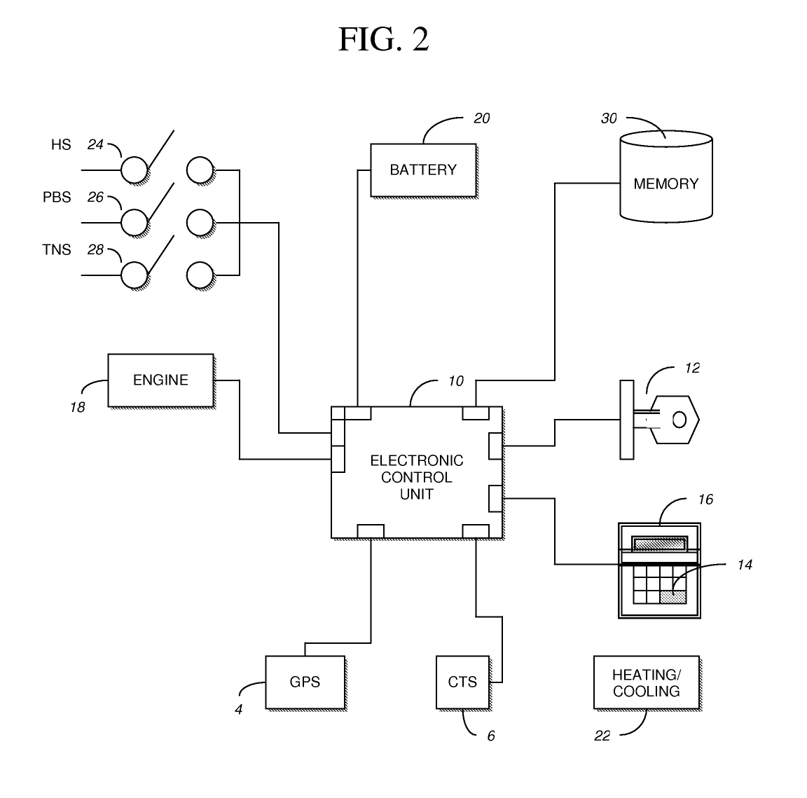

A preferred embodiment of the location determinative engine control system of the present invention employs several integrated elements. FIG. 1 is a schematic illustrating the preferred system's primary components which include: a GPS receiver 4; an operator interface module 16 which includes a system switch 14 for enabling and disabling the entire system; a programmable computer controller 10 such as the engine control unit (ECU); a memory device 30 containing location-related parameters of engine operation; and one or more temperature sensors 6 disposed within a vehicle's cabin area. FIG. 2 illustrates the incorporation of secondary components which include: an ignition switch 12; a hood switch 24; a transmission neutral switch 28; and a parking brake switch 28. The method of the present invention calls for the aforementioned system hardware to be installed in or about a vehicle 1 that is most likely a diesel truck, but may be virtually any motor vehicle having a heating/cooling apparatus 22 of some variety. The ECU 10 is wired for communication with all other system components. However, the location-related engine operation data may, alternatively, be stored in an external data repository with which the ECU 10 communicates by conventional wireless means.

The ECU 10 includes software containing instructions that are compared against inputs received from the other components and are then executed to produce output signals for controlling automated starting and stopping of the vehicle's engine 18. Alternatively, rather than controlling the main engine 18, the ECU 10 can be wired and programmed to control operation of an auxiliary power device engine.

The ignition switch 12 is a typical vehicle ignition switch having on, off and auxiliary positions that are key adjustable. The system switch 14 also has on and off positions so that the vehicle operator may selectively control the operability of system functions. Furthermore, whenever the ignition switch 12 is ON, the control system is disabled irrespective of the system switch's position. Thus, in the particular embodiment shown in FIG. 1, the engine control system may automatically start the engine 18 only when both: (1) the ignition switch 12 is OFF and (2) the system switch 14 is ON. Additional automated start-enabling conditions may also be required, as will be discussed.

The interface module 16 may be simply a digital thermostat or a touch screen device adapted to receive operator inputs regarding cabin temperature and to communicate those inputs to the ECU 10. Whatever its particular form, the interface 16 allows an operator to select a defined range within which he desires that the vehicle's cabin temperature be kept by the system of the present invention. For example, the operator may be prompted to key into the interface 16 high and low temperatures forming limits of an acceptable cabin temperature range. The interface 16 may be further capable of receiving and sending to the ECU 10 an operator's selection of a maximum time interval that the engine 18 is allowed to run continuously. For instance, if the operator prefers that the engine not idle for more than ten consecutive minutes under any circumstances, he may input into the interface 16 a maximum continuous run time selection of 10 minutes. However, such a run time limit selection might be overridden and shortened by the ECU's application of a pertinent local maximum run time parameter received from memory 30.

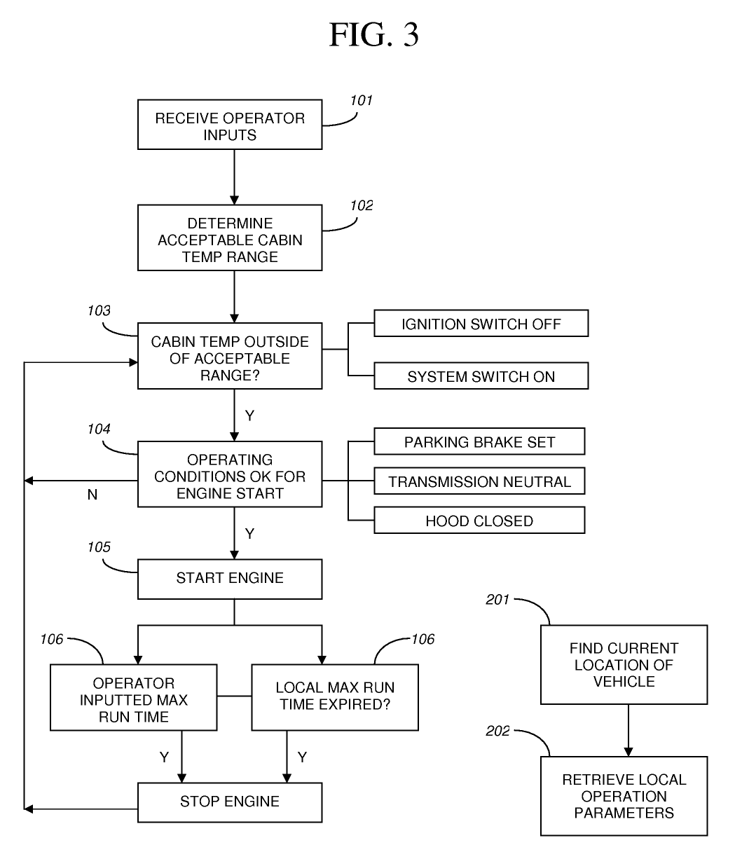

FIG. 3 shows a method flowchart of steps of the location determinative engine control process. In a first step 101, a vehicle operator/driver enters into the interface module 16 a desired cabin temperature. Based upon that input, as step 102, the ECU 10 appropriately recognizes an acceptable range of cabin temperatures. Then, in step 103, the ECU 10 monitors cabin temperature sensors 6 to determine whether the current cabin air temperature is outside of the defined acceptable range. While the current cabin air temperature remains within the acceptable range, the method calls for repeating step 103, and the engine 18 remains dormant. However, once the cabin temperature becomes unacceptable, the method may proceed to the next step 104.

In step 104, the ECU 10 determines whether other attendant operating conditions are acceptable for an ECU-initiated engine startup. For example, it checks signaling to determine if the system switch 14 and ignition switch 12 are in the ON and OFF positions, respectively. The ECU 10 also checks signaling from the parking brake switch 26, transmission switch 28 and hood switch 24 to determine if the parking brake is engaged, the transmission is in neutral and the engine compartment is closed, respectively. These switches provide safety controls to prevent the engine 18 from starting when the vehicle is not safely parked or is undergoing maintenance. If all attendant conditions are deemed acceptable, the engine 18 is automatically started as step 105.

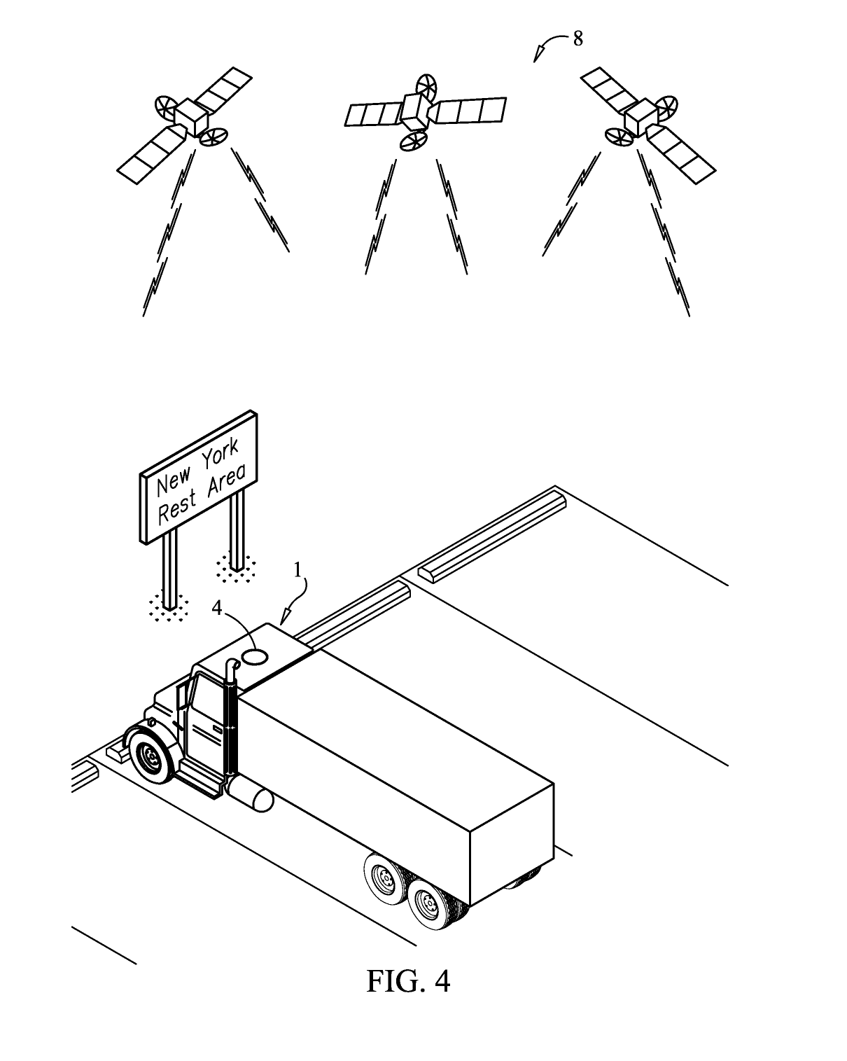

Concurrent with the aforementioned pre-startup steps are processes related to applying any engine operation parameters that are associated with the vehicle's current location. To wit, in a step 201, the ECU 10 is provided the current geographic location of the vehicle. This occurs by virtue of the GPS receiver 4 receiving radio signals transmitted from a constellation of Earth-orbiting satellites (as illustrated in FIG. 4), and then processing that radioed information to determine its latitude and longitude coordinates. However, other known navigation means could be used in place of a GPS system. Nevertheless, with the location determined, in a step 202, the ECU 10 accesses from memory 30 all the stored engine operation parameters that are associated to the particular jurisdiction in which the vehicle currently sits, and it adds those parameters to its engine operation logic. Probably the most commonly retrieved parameter is a maximum engine idling time permitted within the jurisdiction. Generally, local or state law will impose such a limit and possibly others. However, geography-specific engine operation parameters not imposed by law can also be stored in memory 30 and applied by the system computer controller 10.

After the engine 18 begins idling in step 105, the heating/cooling apparatus 22 is enabled to warm or cool the cabin to within the acceptable temperature range. However, manual adjustment of the apparatus 22 may be necessary for optimum effect. Nevertheless, while the engine 18 is running, the ECU 10 repeatedly compares an internal timer reading against the aforementioned maximum idle time parameter received from memory 30 (step 106), and when the maximum idle time expires, the ECU 10 will shut off the engine 18 as step 107. Thereafter, another retrieved local operation parameter may dictate that the engine remain dormant for a certain time period before the entire process can be repeated and the ECU 10 is permitted to restart the engine 18.

What is claimed is:

1. A method for automatically regulating the cabin temperature within a vehicle, the method comprising:
determining the current location of the vehicle by communicating with a navigation system;
retrieving location-specific parameters of engine operation based upon the current location of the vehicle; and
controlling an engine to automatically regulate the cabin temperature in compliance with the location-specific parameters of engine operation.

2. The method of claim 1, wherein said navigation system is a satellite global positioning system (GPS).

3. The method of claim 1, wherein the step of retrieving location-specific parameters comprises communicating with a memory device containing said parameters.

4. The method of claim 1, wherein said location-specific parameters comprise operational limits prescribed by law applicable to the current location of the vehicle.

5. The method of claim 1, wherein said engine is the main engine of the vehicle.

6. The method of claim 1, wherein said engine is an auxiliary power system engine.

7. The method of claim 1, further comprising determining whether vehicle operating conditions are acceptable for controlling an engine.

8. The method of claim 7, wherein vehicle operating conditions acceptable for controlling an engine comprise at least one of the following conditions:
the vehicle's ignition switch being in off or auxiliary position;
the vehicle's parking brake being engaged;
the vehicle's transmission being in neutral position; and
the vehicle's hood being in closed position;

9. The method of claim 1, further comprising controlling an engine to maintain the cabin temperature within a predetermined acceptable temperature range.

10. The method of claim 9, wherein the step of controlling an engine to maintain the cabin temperature within a predetermined acceptable temperature range comprises starting the engine when cabin temperature is outside of said acceptable range.

11. The method of claim 9, wherein said engine is an auxiliary power system engine.

12. A system for automatically regulating the cabin temperature within a vehicle, the system comprising:
a navigation system for determining the current location of the vehicle;
memory containing location-specific parameters of engine operation based upon the current location of the vehicle; and
a computer capable of communicating with the navigation system and the memory, the computer for controlling an engine to automatically regulate the cabin temperature in compliance with the location-specific parameters of engine operation.

13. The system of claim 12, further comprising at least one temperature sensor for determining cabin temperature.

14. The system of claim 13, further comprising an operator interface capable of communicating with said computer, the operator interface for inputting information relative to an acceptable range of cabin temperatures.

15. The system of claim 14, wherein said computer controls an engine in order to maintain the cabin temperature within said acceptable range.

16. The system of claim 12, wherein said computer controls the main engine of the vehicle.

17. The system of claim 12, wherein said computer controls the engine for an auxiliary power system.

18. The system of claim 13, further comprising at least one temperature sensor for determining ambient temperature.

19. The system of claim 12, further comprising at least one of the following:
a hood switch capable of communicating to said computer that the vehicle's hood is in closed position;
a parking brake switch capable of communicating to said computer that the vehicle's parking brake is engaged; and
a transmission switch capable of communicating to said computer that the vehicle's transmission is in neutral position.

20. The system of claim 12, wherein said memory is located remote from the vehicle, whereby said computer communicates wirelessly with said memory.
